(19) United States
(12) Patent Application Publication
(10) Pub. No.: US 2011/0022916 A1
(43) Pub. Date: Jan. 27, 2011

(54) METHOD AND SYSTEM FOR SAVING POWER FOR PACKET RE-TRANSMISSION IN AN ENCRYPTED BLUETOOTH LOW POWER LINK LAYER CONNECTION

(76) Inventors: Prasanna Desai, Elfin Forest, CA (US); Brima Ibrahim, Aliso Viejo, CA (US)

Correspondence Address: MCANDREWS HELD & MALLOY, LTD, 500 WEST MADISON STREET, SUITE 3400, CHICAGO, IL, 60661, US

(21) Appl. No.: 12/546,628

(22) Filed: Aug. 24, 2009

Related U.S. Application Data
(60) Provisional application No. 61/228,370, filed on Jul. 24, 2009.

(51) Int. Cl. H04L 1/18; H04L 9/00; H03M 13/09; G06F 11/10; G06F 11/07; G06F 1/32

(52) U.S. Cl. 714/748; 380/46; 380/270; 714/E11.032; 714/E11.023

(57) ABSTRACT

A Bluetooth low power (BLE) receiver receives a data packet in an encrypted link layer connection from a BLE transmitter. The data packet comprises a transmitted protocol data unit (PDU) and associated cyclic redundancy code (CRC). The PDU comprises a message integrity code (MIC). The BLE receiver determines a connection SNR. In a high connection SNR condition, the BLE receiver determines packet retransmission based on MIC verification without CRC checking. A MIC indication is generated by comparing a local MIC and the MIC in the received data packet. CRC checking is turned on or off for power saving based on the MIC indication and connection SNR. In a high connection SNR, the BLE receiver determines, without CRC checking, to retransmit the received data packet for a MIC failure indication. The local MIC is calculated using a shared secret Encryption Key of 32-bit, 64-bit or 128-bit derived from multiple entropy pools.

### CROSS-REFERENCE TO RELATED APPLICATIONS/INCORPORATION BY REFERENCE

This patent application makes reference to, claims priority to and claims benefit from U.S. Provisional Patent Application Ser. No. 61/228,370 filed on Jul. 24, 2009.

The above stated application is hereby incorporated herein by reference in its entirety.

### FIELD OF THE INVENTION

Certain embodiments of the invention relate to signal processing for communication systems. More specifically, certain embodiments of the invention relate to a method and system for saving power for packet re-transmission in an encrypted Bluetooth low power layer connection.

### BACKGROUND OF THE INVENTION

The Bluetooth low energy (BLE) is a specification that enables radio frequency communication operating within the globally accepted 2.4 GHZ Industrial, Scientific & Medical (ISM) band. The BLE specification supports a physical layer bit rate of 1 Mbit/s over a range of 5 to 15 meters. The BLE wireless technology specification features two implementations, namely “dual-mode” and “single-mode”. In the dual-mode implementation, BLE functionality is an add-on feature within traditional Bluetooth, sharing a great deal of existing functionality resulting in a minimal cost increase compared to existing Bluetooth enabled devices. The dual mode implementation is targeted at mobile devices and personal computers. The single-mode implementation is power and cost optimized. The single-mode implementation features a lightweight Link Layer (LL) providing ultra-low power idle mode operation, simple device discovery and reliable point-to-multipoint data transfer with advanced power-save and encryption functionalities. The single-mode implementation is targeted at small, button cell battery power devices in, for example, sports and wellness, healthcare, entertainment and toys and mobile accessories product categories. The BLE offers connectivity between mobile devices or personal computers, and small button cell battery power devices. Applications for BLE wireless technology comprise leisure, healthcare, entertainment and office.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for a saving power for packet re-transmission in an encrypted Bluetooth low power layer connection, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary Bluetooth low energy communication system that utilizes a message integrity code for power saving in packet re-transmissions in an encrypted Bluetooth low power link layer connection, in accordance with an embodiment of the invention.

FIG. 2 is a diagram illustrating an exemplary Bluetooth low energy master device that is operable to manage packet transmission and retransmission in an encrypted Bluetooth low power link connection using a message integrity code, in accordance with an embodiment of the invention.

FIG. 3 is a diagram illustrating an exemplary Bluetooth low energy slave device that is operable to manage packet transmission and retransmission in an encrypted Bluetooth low power link connection using a message integrity code, in accordance with an embodiment of the invention.

FIG. 4 is a diagram illustrating an exemplary Bluetooth low energy data format, in accordance with an embodiment of the invention.

FIG. 5 is a diagram illustrating an exemplary Bluetooth low energy message integrity operation, in accordance with an embodiment of the invention.

FIG. 6 is a flow chart illustrating exemplary steps to determine packet re-transmission in an encrypted Bluetooth low power link layer connection, in accordance with an embodiment of the invention.

FIG. 7 is a flow chart illustrating exemplary steps to determine packet re-transmission based on an adaptive CRC detection, in accordance with an embodiment of the invention.

FIG. 8 is a diagram illustrating an exemplary pseudo random number generator that generates a random number using multiple entropy pools for generation of a secret Encryption Key, in accordance with an embodiment of the invention.

FIG. 9 is a diagram illustrating an exemplary entropy bit collector that is operable to collect entropy bits in multiple entropy pools for generating a random number for generation of a secret Encryption Key, in accordance with an embodiment of the invention.

FIG. 10 is a diagram illustrating an exemplary seed entropy processor that is operable to select seed entropy from entropy bits collected in multiple entropy pools for generation of a secret Encryption Key, in accordance with an embodiment of the invention.

FIG. 11 is a diagram illustrating an exemplary pseudo random generator that is operable to generate a random number using multiple entropy pools for generation of a secret Encryption Key, in accordance with an embodiment of the invention.

FIG. 12 is a flow chart illustrating exemplary steps to generate a random number using a multiple entropy pools for generation of a secret Encryption Key, in accordance with an embodiment of the invention.

FIG. 13 is a flow chart illustrating exemplary steps to expedite random number generation by iterating pseudo random generator for generation of a secret Encryption Key, in accordance with an embodiment of the invention.

### DETAILED DESCRIPTION OF THE INVENTION

Certain embodiments of the invention may be found in a method and system for saving power for packet re-transmission in an encrypted Bluetooth low power layer connection. In accordance with various exemplary embodiments of the invention, a Bluetooth low power (BLE) receiver is operable to receive a data packet in an encrypted link layer connection from a Bluetooth low power (BLE) transmitter. The data packet comprises a transmitted protocol data unit (PDU) and associated cyclic redundancy code (CRC). The transmitted PDU may comprise a message integrity code (MIC). The BLE receiver may be operable to determine a SNR associated with the encrypted link layer connection. The BLE receiver may be enabled to perform MIC verification on the received data packet for data integrity. In a high signal-to-noise ratio (SNR), the BLE receiver may be configured to determine packet retransmission based on the MIC verification. In this regard, the BLE receiver may be enabled to calculate a local MIC for the transmitted PDU using a secret Encryption Key shared with the BLE transmitter. The BLE receiver is operable to generate a MIC indication by comparing the local MIC and the MIC in the received data packet. A MIC success indication may be generated in instances when the local MIC is the same as the MIC in the received data packet. A MIC failure indication may be generated in instances when the local MIC is different from the MIC in the received data packet. The BLE receiver is operable to turn ON or OFF CRC checking to achieve power saving based on the generated MIC indication and connection SNR.

In a connection in which there is a high SNR, the BLE receiver may be operable to determine, without CRC checking, whether the received data packet should be retransmitted due to a MIC failure indication. The shared secret Encryption Key may be derived from a random number sequence generated by a random number generator fed with seed entropy selected from multiple entropy pools such as an analog-to-digital convertor (ADC) entropy pool and a low power oscillator (LPO) entropy pool, which may be formed from inherent randomness of various occasional and/or unlikely events on an ADC and a LOP, respectively. The random number generator is operable to generate random numbers of 32-bit, 64-bit, or 128-bit for various purposes, for example, to create a secret Encryption Key of 32-bit, 64-bit, or 128-bit, respectively.

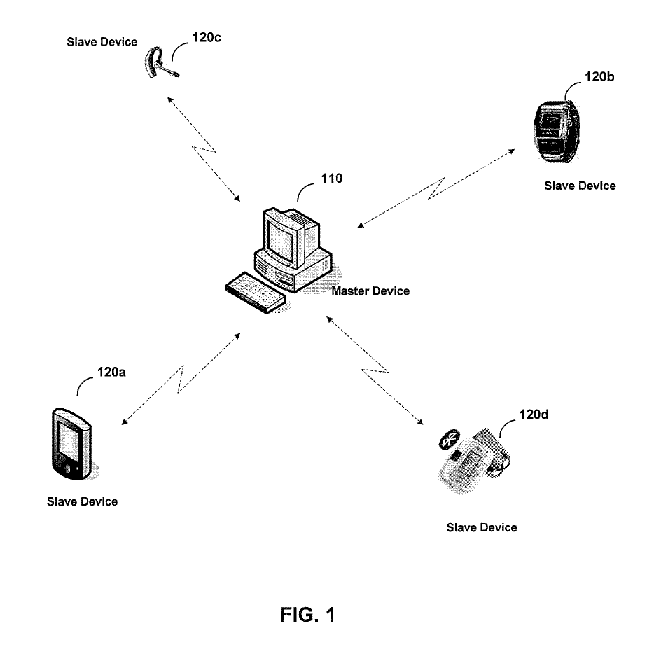

FIG. 1 is a diagram illustrating an exemplary Bluetooth low energy communication system that utilizes a message integrity code for power saving in packet re-transmissions in an encrypted Bluetooth low power link layer connection, in accordance with an embodiment of the invention. Referring to FIG. 1, there is shown a Bluetooth low energy (BLE) communication system 100 comprising a master device 110 and a plurality of slave devices, of which slave devices 120a-120d are displayed.

The BLE communication system 100 may be operational to utilize a frequency division multiple access (FDMA) scheme and a time division multiple access (TDMA) scheme for vice and/or data communication. The communication system 100 may be configured to pre-divide a plurality of physical channels, for example, 40 physical channels, into advertising channels and data channels per FDMA scheme. The communication system 100 may be enabled to utilize a TDMA based polling scheme for link layer communications. When connected, a BLE device may be configured to operate as either a master device or a slave device for the associated link layer connection.

The master device 110 may comprise suitable logic, circuitry and/or code that may be enabled to communicate with a plurality of peripheral slave devices such as the slave devices 120a-120d in corresponding link layer connections. The master device 110 may be enabled to support multiple link layer connections at a time to a plurality of intended slave devices such as the slave devices 120a-120d. The master device 110 may be operable to initiate a link layer connection with an intended slave device such as the slave device 120d. The master device 110 may be enabled to sending a connection request packet such as a Connect_REQ packet to the slave device 120d in an advertising channel, in which the slave device 120d is advertising, for setting up a link layer connection with the slave device 120d. The Connect_REQ packet may comprise unique link layer connection parameters such as, for example, hopping frequency length (Hop_length). The Hop_length may be utilized by both the master device 110 and the slave device 120d to calculate a data channel index utilizing a channel selection algorithm. The master device 110 may be enabled to communicate data packets with the slave device 120d in a data channel with the calculated data channel index.

The master device 110 may be operable to manage various aspects of data packet communication with the slave device 120d in the link layer connection. For example, the master device 110 may be enabled to determine operation schedule for the link layer connection with the slave device 120d. The master device 110 may be enabled to initiate a packet exchange sequence in the link layer connection with its own transmission. In the communication system 100, connection events are run for data channels of the link layer connections. Data packet transmissions may take place in connection events. The master device 110 may be enabled to determine timing and duration for each connection event. For example, connection event timing may be determined based on the master device's Bluetooth clock. During a connection event, data packets may be transmitted with, for example, 150 μs spacing and at least one data packet is from the master device 110 in the connection event. The master device 110 may be configured to transmit the first data packet in each connection event to an intended slave device such as the slave device 120d. Transmission of the first data packet in each connection event may vary from 1.25 ms to 4.85 ms.

A slave device such as the slave device 120a may comprise suitable logic, circuitry and/or code that may be enabled to communicate with a master device such as the master device 110 in an associated link layer connection. The slave device 120a may be associated with one link layer connection with the master device 110. The slave device 120a may be enabled to synchronize to connection event start points, referred to as anchor points, from a slave's perspective, for data communication with the master device 110. The slave device 120a may consider that a connection setup with the master device is complete after a connection request (CONNECT_REQ) packet is successfully received via an advertising channel from the master device 110. The slave device 120a may be enabled to calculate a data channel index using a channel selection algorithm for each connection event in associated link layer connection. The data channel index may be determined based on a hopping frequency length (Hop_length) in the received CONNECT_REQ packet. The slave device 120a may be enabled to move to a data channel with the calculated data channel index to communicate data packets with the master device 110. The slave device 120a may be configured to communicate data packets to the master device 110 in the data channel after the first data packet in a connection event received in the data channel from the master device 110.

In Bluetooth low power, a link layer connection between the master device 110 and an intended slave device such as the slave device 120a may be configured to operate in one of two modes—encrypted or un-encrypted. The master device 110 may be enabled to initiate an encrypted mode in the link layer connection with the slave device 120a when needed. In an encrypted link layer connection, a transmitted protocol data unit (PDU) in a data packet may be ended with a message integrity code (MIC). A cyclic redundancy code (CRC) may be attached to the end of the transmitted PDU. The transmitted PDU may be protected by incorporating MIC verification and a CRC check for message authentication. The MIC may be calculated using a secret Encryption Key, which may be shared by the master device 110 and the slave device 120a to protect data packets from undetected alteration in the encrypted link layer connection. The CRC and the MIC may be calculated, separately.

For transmission, a CRC and a MIC may be calculated, separately. A secret Encryption Key, which may be shared with an intended recipient, may be used to calculate the MIC. The calculated MIC may be appended to the end of the transmitted PDU payload. The calculated CRC may be attached to the appended calculated MIC to form a data packet for transmission to the intended recipient in a corresponding encrypted link layer connection. The transmitted PDU in the data packet may be encrypted before transmission to the intended recipient in the corresponding encrypted link layer connection.

For reception, the recipient may be enabled to receive the data packet in the encrypted link layer connection. The received data packet may be decrypted and authenticated before CRC checking. The recipient may be enabled to utilize the shared secret Encryption Key to calculate a local MIC for an associated PDU in the received data packet. The calculated local MIC may be utilized to authenticate the received data packet. In this regard, the calculated local MIC may be compared to the MIC in the received data packet to authenticate the received data packet. A MIC success indication may be created if the calculated local MIC is the same as the MIC in the received data packet. A difference between the local calculated MIC and the MIC in the received data packet may cause a MIC failure indication. In this regard, in order to save power, the MIC failure indication may be utilized to determine a packet retransmission without further performing CRC checking in a high SNR condition. On a MIC failure because of, for example, interference and/or bit flipping attack in the associated PDU of the received data packet, the recipient may be enabled to notify the packet sender with a MIC failure indication. The recipient may be enabled to utilize the MIC failure indication for data packet retransmission without CRC checking. The sender may be configured to retransmit the data packet upon receiving the MIC failure indication from the recipient. The encrypted link layer connection may be maintained during the data packet retransmission.

The shared secret Encryption Key may be generated from a random number sequence. In this regard, the generated secret Encryption Key may be in a variable length such as, for example, 32-bit, 64-bit, and 128-bit. The random number sequence may be generated utilizing an entropy seed selected from multiple entropy pools such as, for example, a low power oscillator (LPO) entropy pool and an ADC entropy pool.

In an exemplary operation, the master device 110 may be enabled to initiate a link layer connection setup with an intended slave device such as the slave device 120a. The master device 110 may be operable to initiate an encryption in the link layer connection. In instances where the master device 110 may need to transmit PDUs to the slave device 120a in the encrypted link layer connection. The master device 110 may be operable to append a MIC to the end of the PDU payload of a PDU for transmission. The attached CRC may be calculated on the PDU. The appended MIC may be calculated using a secret Encryption Key, which is shared with the slave device 120a for data authentication. The PDU may be encrypted before transmission. A data packet comprising the encrypted PDU and the attached CRC may be transmitted to the slave device 120a in the encrypted link layer connection.

At the receiving end, the slave device 120a may be enabled to receive the data packet via the encrypted link layer connection. The slave device 120a may be configured to decrypt and authenticate the received data packet before CRC checking. The slave device 120a may be enabled to calculate a local MIC for an associated PDU in the received data packet for authenticating the received data packet. A secret Encryption Key shared with the master device 110 may be utilized in calculating the local MIC. The calculated local MIC may be compared to the MIC in the associated PDU of the received data packet for data integrity. A MIC success indication may be issued when the calculated local MIC is the same as the MIC in the received data packet. In instances where there is a difference between the local calculated MIC and the MIC in the received data packet, a MIC failure indication may be generated. In this regard, in a high SNR condition, the slave device 120a may be configured to utilize the MIC failure indication for packet retransmission without performing CRC checking. The master device 110 may be configured to retransmit corresponding data packet upon receiving the MIC failure indication from the slave device 120a. The encrypted link layer connection may be maintained during data packet retransmission.

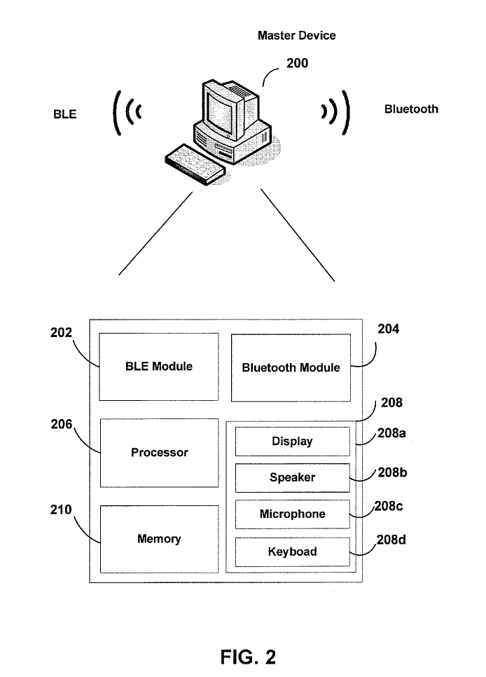

FIG. 2 is a diagram illustrating an exemplary Bluetooth low energy master device that is operable to manage packet transmission and retransmission in an encrypted Bluetooth low power link connection using a message integrity code, in accordance with an embodiment of the invention. Referring to FIG. 2, there is shown a master device 200. The master device 200 comprises a BLE module 202, a Bluetooth module 204, a processor 206, a user interface 208, and a memory 210. The user interface 208 may comprise a display 208a, a speaker 208b, a microphone 208c, and a keyboard 208d.

The BLE module 202 may comprise suitable logic, circuitry, interfaces and/or code that may be enabled to transmit and/or receive signals over Bluetooth low power air interface and communicate with the processor 206 for further processing.

The Bluetooth module 204 may comprise suitable logic, circuitry, interfaces and/or code that may be enabled to transmit and/or receive signals over the Bluetooth air interface. The Bluetooth module 204 may be enabled to communicate the signals with the processor 206 for further processing.

The processor 206 may comprise suitable logic, circuitry, interfaces and/or code that may be enabled to perform a variety of signal processing tasks associated with the BLE module 202 and/or the Bluetooth module 204. The processor 206 may be operable to control the BLE module 202 as well as the Bluetooth module 204. For example, the processor 206 may be operable to initiate a link layer connection via the BLE module 202 with an advertiser. When connected, the processor 206 may be configured to initiate an encryption in the link layer connection with an intended slave device such as the slave device 120a. The processor 206 may be enabled to transmit and/or receive encrypted data packets in the encrypted link layer connection with the slave device 120a via the BLE module 202.

For packet transmission, the master device 200 may need to transmit PDUs in the encrypted link layer connection. The processor 206 may be enabled to calculate a CRC on a PDU to be transmitted and attach the calculated CRC to the end of the PDU. The processor 206 may be operable to calculate a MIC for the PDU using a secret Encryption Key, which is shared with the slave device 120a. The PUD is ended with the calculated MIC. A data packet may comprise the PDU and the attached CRC. The PDU may be encrypted before transmitting via the BLE module 202 in the encrypted link layer connection. In this regard, the processor 206 may be configured to control packet retransmission based on a MIC indication associated with the transmitted PDU from the slave device 120a. The MIC indication may be generated by the slave device 120a for data integrity. In a high SNR condition, a MIC failure indication from the slave device 120a may cause packet retransmission via the processor 206 to the slave device 120a. The processor 206 may be configured to maintain the encrypted link layer connection during the packet retransmission.

For packet reception, the master device 200 may be enabled to receive a data packet via the BLE module 202 from, for example, the slave device 120a in the encrypted link layer connection. The processor 206 may be enabled to decrypt and authenticate the received data packet. A local MIC may be calculated for an associated transmitted PDU in the received data packet using a secret Encryption Key, which is shared with the slave device 120a and is derived from multiple entropy pools, for example, low power oscillator entropy pool and ADC entropy pool. The processor 206 may be enabled to authenticate the received data packet by comparing the calculated local MIC with the MIC in the received data packet. The processor 206 may be enabled to generate a MIC success indication if the calculated local MIC is the same as the MIC in the received data packet. The processor 206 may be enabled to generate a MIC failure indication in instances where the calculated local MIC is different from the MIC in the received data packet. In this regard, in a high SNR condition, the processor 206 may be configured to turn off CRC checking when a MIC failure may occur. The processor 206 may be configured to utilize the generated MIC failure indication for packet retransmission. The encrypted link layer connection may be maintained during data packet retransmission.

The user interface 208 may comprise suitable logic, circuitry, interfaces and/or code that may be enabled to service the master device 200 via user inputs and/or presentation of various services to users. The user interface 208 may comprise a plurality of associated components such as the display 208a, the speaker 208b, the microphone 208c, and the keyboard 208d. The display 208a may enable presentation or display graphics and/or text to users. Services implemented via the BLE module 202 and/or the Bluetooth module 204 may be presented to users as image data on the display 208a and/or as voice via the speaker 208b, for example, by pressing the keyboard 208d and/or generating an audio indication through the microphone 208c.

Although a BLE master device is illustrated in FIG. 2 as the dual mode master device 200, the invention is not so limited. In this regard, the master device may be a single mode master device. The BLE module 202, the processor 206, the user interface 208 may be operable to support corresponding single mode operations as a BLE master device without departing from the spirit and scope of the various embodiments of the invention.

The memory 210 may comprise suitable logic, circuitry, interfaces and/or code that may enable storage of data and/or other information utilized by the processor 206. For example, the memory 208 may be utilized to store data communicated via the BLE module 202 and the Bluetooth module 204. The memory 208 may be enabled to store executable instructions received from the BLE module 202 to wake up or turn off, for example, CRC checking. The memory 208 may be enabled to store algorithms to calculate a MIC and/or a CRC. The memory 210 may comprise RAM, ROM, low latency nonvolatile memory such as flash memory and/or other suitable electronic data storage capable of storing data and instructions.

In operation, the master device 200 may be enabled to initiate an encrypted link layer connection with an intended slave device such as, for example, the slave device 120a. The processor 206 may be operable to communicate data packets via the BLE module 202 with the slave device 120a in the encrypted link layer connection. A data packet comprises a transmitted PDU and a CRC. The transmitted PDU comprises a MIC, which is attached to the end of the PDU payload. The transmitted PDU may be encrypted before transmission. The processor 206 may be configured to control data packet transmission using a MIC associated with the transmitted PDU. For transmission, the processor 206 may be configured to utilize a MIC indication from the slave device 120a to control data packet re-transmission. In this regard, in a high SNR, the processor 206 may be configured to re-transmit a data packet when a MIC failure indication associated with the data packet may be received from the slave device 120a. For reception, the processor 206 may be configured to utilize a MIC for data integrity as well as packet acknowledgement. In this regard, in a high SNR, the processor 206 may be configured to send a MIC failure indication to the slave device 120a for data packet re-transmission without CRC checking. The processor 206 may be enabled to maintain the encrypted link layer connection for packet retransmission.

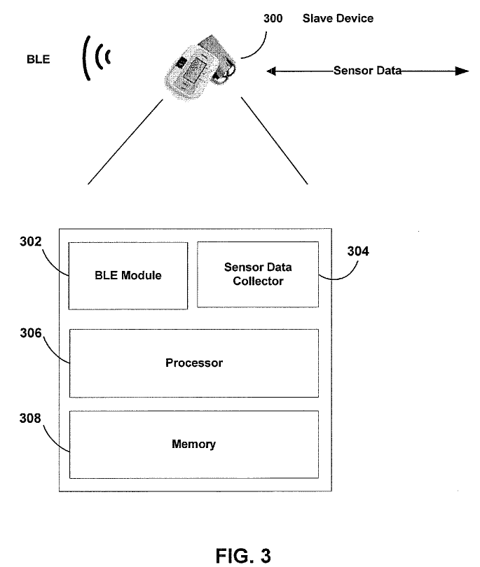

FIG. 3 is a diagram illustrating an exemplary Bluetooth low energy slave device that is operable to manage packet transmission and retransmission in an encrypted Bluetooth low power link connection using a message integrity code, in accordance with an embodiment of the invention. Referring to FIG. 3, there is shown a slave device 300. The slave device 300 comprises a BLE module 302, a sensor data collector 304, a processor 306 and a memory 308.

The BLE module 302 may comprise suitable logic, circuitry, interfaces and/or code that may be enabled to transmit and/or receive radio signals over BLE air interface and convert them to corresponding signals, which may be suitable for further processing in the processor 306.

The sensor data collector 304 may comprise suitable logic, circuitry, interfaces, and/or code that may be enabled to collect sensor data from a target device. The collected sensor data may comprise, for example, running speed, body temperature, and/or blood pressure. The collected data may be communicated with various central devices such as the master device 200 for further analysis.

The processor 306 may comprise suitable logic, circuitry, interfaces and/or code that may be enabled to perform a variety of signal processing tasks, which may comprise controlling of the BLE module 302 as well as the sensor data collector 304, for example. The processor 306 may be enabled to start communicating data packets with the master device 200 in a link layer connection initiated by the master device 200. When encryption is initiated by the master device 200 in the link layer connection, the processor 306 may be enabled to transmit and/or receive encrypted data packets in the encrypted link layer connection with the master device 200 via the BLE module 302.

In packet transmission, the slave device 300 may need to transmit PDUs in the encrypted link layer connection. The processor 306 may be enabled to calculate a CRC on a transmitted PDU and attach the calculated CRC to the transmitted PDU. Each transmitted PDU comprises a MIC, which is calculated using a secret Encryption Key. The secrete MIC is shared with the master device 200. A data packet may be formed by appending the calculated CRC to the end of the transmitted PDU. The transmitted PDU may be encrypted before transmitting via the BLE module 302 in the encrypted link layer connection. In this regard, the processor 306 may be configured to control packet retransmission based on a MIC indication associated with the transmitted PDU from the master device 200. The MIC indication may be generated by the master device 200 for data integrity. In a high SNR condition, a MIC failure indication from the master device 200 may cause packet retransmission via the processor 306 to the master device 200. The processor 306 may be configured to maintain the encrypted link layer connection during the packet retransmission.

For packet reception, the slave device 300 may be enabled to receive a data packet via the BLE module 302 from, for example, the master device 200 in the encrypted link layer connection. The processor 306 may be enabled to decrypt and authenticate the received data packet. A local MIC may be calculated for received PDU in the received data packet using a secret Encryption Key. The secret Encryption Key is shared with the master device 200 and is derived from multiple entropy pools, for example, low power oscillator entropy pool and ADC entropy pool. The processor 306 may be enabled to authenticate the received data packet by comparing the calculated local MIC with the MIC in the received data packet. The processor 306 may be enabled to generate a MIC success indication in instances where the calculated local MIC is the same as the MIC in the received data packet. The processor 306 may be enabled to generate a MIC failure indication in instances where the calculated local MIC is different from the MIC in the received data packet. In this regard, in a high SNR condition, the processor 306 may be configured to escape CRC checking when a MIC failure may occur. The processor 306 may be configured to utilize the generated MIC failure indication for packet retransmission. The encrypted link layer connection may be maintained during data packet retransmission.

Although a slave device is illustrated in FIG. 3 as the single mode slave device 300, the invention is not so limited. In this regard, the slave device may be a dual mode slave device. The processor 306 may be operable to support corresponding dual mode operations as a slave device without departing from the spirit and scope of the various embodiments of the invention.

The memory 308 may comprise suitable logic, circuitry, interfaces and/or code that may enable storage of data and/or other information utilized by the processor 306. For example, the memory 308 may be utilized to store collected sensor data from the sensor data collector 304. For example, the memory 308 may be enabled to store various algorithms for calculating MIC and/or CRC. The memory 308 may be enabled to store executable instructions received from the BLE module 302 to wake up or turn off, for example, CRC checking. The memory 210 may comprise RAM, ROM, low latency nonvolatile memory such as flash memory and/or other suitable electronic data storage capable of storing data and instructions.

In operation, the slave device 300 may be enabled to communicate data packets with the master device 200 in an encrypted link layer connection. The processor 306 may be operable to communicate data packets via the BLE module 302 with the master device 200. A data packet comprises a PDU and a CRC. The PDU comprises a MIC, which is attached to the end of the PDU payload. The PDU may be encrypted before transmission. The processor 306 may be configured to control data packet transmission using a MIC in the PDU. For transmission, the processor 306 may be configured to utilize a MIC indication from the master device 200 to control data packet re-transmission. In this regard, in a high SNR, the processor 306 may be configured to re-transmit a data packet when a MIC failure indication associated with the data packet may be received from the master device 200. For reception, the processor 306 may be configured to utilize a MIC for data integrity as well as packet acknowledgement. In this regard, in a high SNR condition, the processor 306 may be configured to send a MIC failure indication to the master device 200 for data packet re-transmission without CRC checking. The processor 306 may be enabled to maintain the encrypted link layer connection for packet retransmission.

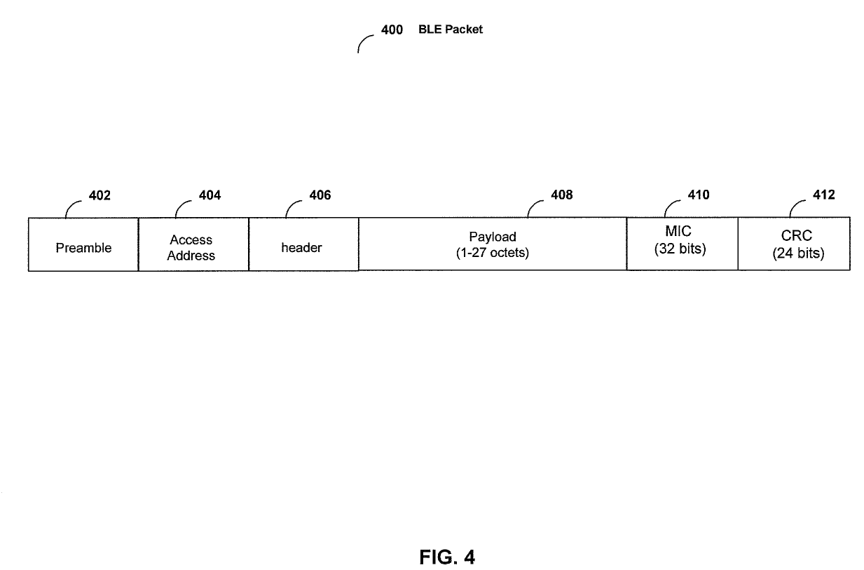

FIG. 4 is a diagram illustrating an exemplary Bluetooth low energy data format, in accordance with an embodiment of the invention. Referring to FIG. 4, there is shown a BLE packet 400 comprise a preamble 402, an access address 404, a header 406, a payload 408, a MIC 410, and a CRC 412.

The preamble 402 may comprise eight bit long sequence of either ‘10101010’ or ‘01010101’. An advertising channel packet may use ‘01010101’ as the preamble 402. The preamble 402 may comprise either ‘10101010’ or ‘01010101’ for a data channel packet. The preamble 402 may be used by a BLE receiver to perform frequency synchronization, symbol timing estimation, and gain control training.

The access address 404 may comprise a 32-bit value. The access address 404 may comprise a bit string of ‘01101011011111011001000101110001’ for an advertising channel packet. The access address 404 in data channel packets may be unique for each link layer connection. The access address 404 in data channel packets may comprise a pseudo-random 32-bit value.

The header 406 may comprise control information associated with packet and link. For example, the header 406 may comprise a hopping frequency length, which may be utilized to calculate a data channel index by a master device and a slave device. The header 406 may comprise information such as, for example, flow control, sequencing and packet acknowledgement, crucial to a correct operation of the link.

The payload 408 may comprise actual data and/or control information in a Protocol Data Unit (PDU) from higher layers. The payload 408 may be in a variable size.

The MIC 410 is a message integrity code. The MIC 410 may take values of, for example, 32, 64 or 128. The MIC 410 may be utilized to detect potential packet content alteration such as bit flipping in the payload 408 due to transmission errors or deliberate manipulation. The MIC 410 may be utilized to determine the level of data integrity at reception. In this regard, the MIC 410 may be utilized for determining packet retransmission without CRC checking at the reception. For example, in a high SNR, a MIC failure indication at the reception may lead the BLE packet 400 to be retransmitted.

The cyclic redundancy check (CRC) 412 is appended to the MIC 410 to allow integrity verification and a packet retransmission mechanism. The CRC 412 may be calculated for the header 406 and the payload 408. The CRC 412 may be utilized as a measure of determining if the BLE packet 400 may need to be retransmitted. For example, upon the reception of the BLE packet 400, a local CRC may be calculated on the header 406 and the payload 408. The local CRC may be compared to the CRC 412 in the BLE packet 400 for packet acknowledgement. The BLE packet 400 may be acknowledged in instances where the local CRC matches the CRC 412. A mismatch between the local CRC and the CRC 412 may cause the BLE packet 400 to be retransmitted.

In an exemplary operation, the BLE packet 400 may be communicated via an encrypted link layer connection in a BLE system. At the reception, the preamble 402 may indicate the type of the BLE packet 400 such as an advertising packet or a data packet. The preamble 402 may be used for frequency synchronization to particular operating frequencies assigned to a specific link layer connection. The specific link layer connection may be specified via the access address 404. The header 406 in the BLE packet 400 may be decoded for packet control information. The payload 408 may be decoded using the packet control information decoded from the header 406. A local MIC may be calculated on the header 406 and the payload 408. The local MIC may be compared with the MIC 410 in the BLE packet 400 for data integrity. A MIC success indication may be generated in instances where the local MIC is the same as the MIC 410. A MIC failure indication may be generated in instances where the local MIC is different from the MIC 410. In this regard, in a high SNR condition, a MIC failure indication may cause the BLE packet 400 to be retransmitted without checking the CRC 412 in the encrypted link layer connection.

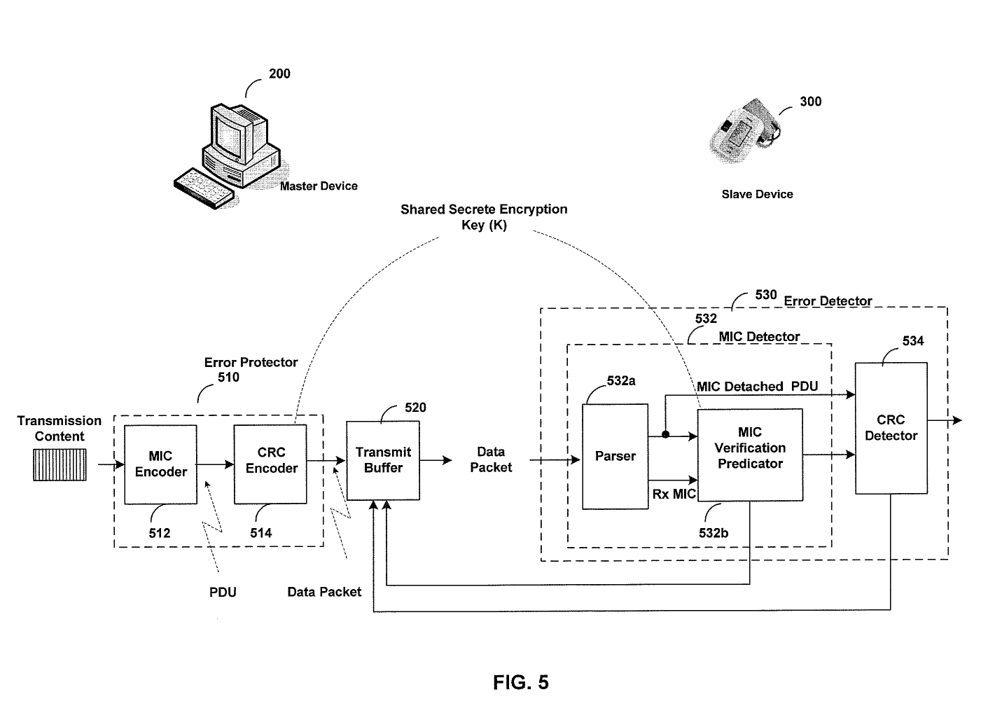

FIG. 5 is a diagram illustrating an exemplary Bluetooth low energy message integrity operation, in accordance with an embodiment of the invention. Referring to FIG. 5, there is shown a master device 200 and a slave device 300. The master device 200 comprises an error protector 510 and a transmit buffer 520. The slave device 300 comprises an error detector 530. The error protector 510 comprises a MIC encoder 512 and a CRC encoder 514. The error detector 530 comprises a MIC detector 532 and a CRC detector 534. The MIC detector 532 further comprises a parser 532a and a MIC verification predicator 532b.

The error protector 510 may comprise suitable logic, circuitry, interfaces and/or code that may enable error protection on a PDU transmission. The error protector 510 may be enabled to apply various error protection schemes such as CRC checking and/or MIC verification for the PDU transmission.

The MIC encoder 512 may comprise suitable logic, circuitry, interfaces and/or code that may enable a MIC encoding on transmission content for a PDU. The transmission content may comprise, for example, the preamble 402, the access code 404, the header 406, and the payload 408. The MIC encoder 512 may be enabled to calculate a MIC on the transmission content using a secret Encryption Key, which is shared with an intended slave device such as the slave device 300. The secret Encryption Key may be derived from a pseudo random number sequence. The pseudo random number sequence may be generated using an entropy seed selected from multiple entropy pools such as, for example, an LPO entropy pool and an ADC entropy pool. The MIC encoder 514 may be enabled to form the PDU for transmission by appending the calculated MIC to the transmission content. The MIC encoder 514 may be enabled to communicate the PDU to CRC encoder 514.

The CRC encoder 514 may comprise suitable logic, circuitry, interfaces and/or code that may enable a CRC encoding on the PDU from the MIC encoder 512. The CRC encoder 514 may be enabled to calculate a CRC on the PDU. The CRC encoder 514 may be enabled to attach the calculated CRC to the end of the PDU to form a data packet for transmission. The CRC encoder 514 may be operable to communicate the data packet to the buffer 520 for transmission in the encrypted link layer connection to the slave device 300.

The transmit buffer 520 may comprise suitable logic, circuitry, interfaces and/or code that may enable buffering incoming data packets from the error protector 510. The transmit buffer 520 may be operable to manage packet transmission and retransmission in an encrypted link connection to the slave device 300. The capability of packet retransmission may enable correcting transmission errors in transmitted data packets. The transmit buffer 520 may be configured to manage packet transmission and retransmission based on error detection information received from the slave device 300. In this regard, the error detection information may comprise a CRC indication and/or a MIC indication. A CRC indication and a MIC indication may be generated by the slave device 300 at the reception of a data packet. The transmit buffer 520 may be operable to utilize the CRC indication to control packet transmission and/or retransmission and utilize the MIC indication for data integrity. In this regard, in a high SNR condition, the transmit buffer 520 may be configured to utilize the MIC indication for packet acknowledgement in addition to data integrity. The transmit buffer 520 may be enabled to manage retransmission of a data packet in instances where a MIC failure indication associated with the data packet may be received from the slave device 300.

The error detector 530 may comprise suitable logic, circuitry, interfaces and/or code that may enable detecting transmission errors in received data packets. The error detector 530 may be enabled to determine whether a received data packet may be erroneous via the MIC detector 532 and/or the CRC detector 534.

The MIC detector 532 may comprise suitable logic, circuitry, interfaces and/or code that may be enabled to detect errors in transmission and reception for data integrity. The MIC detector 532 may be enabled to perform MIC verification to validate received data packets.

The parser 532a may comprise suitable logic, circuitry, interfaces and/or code that may be enabled to analyze and classify bitstreams of received data packets. The parser 532a may be enabled to extract a MIC in a received data packet. The extracted MIC may be communicated with the MIC verification predicator 532b for MIC verification. The parser 532a may be enabled to detach the MIC from an associated PDU of the received data packet. The remaining content of the received data packet may be communicated to the MIC verification predictor 532b for MIC analysis and to the CRC detector 534 for CRC analysis, respectively.

The MIC verification predictor 532b may comprise suitable logic, circuitry, interfaces and/or code that may be enabled to detect potential packet content altercation due to, for example, transmission error or deliberate manipulation. The MIC verification predictor 532b may be enabled to calculate a local MIC for the associated PDU in the received data packet. The local MIC is calculated using a secret Encryption Key, which is shared with the master device 200. The MIC verification predictor 532b may be enabled to compare the local MIC with the MIC in the received data packet to determine data integrity. The MIC verification predictor 532b may be configured to generate a MIC success indication in instances where the local MIC is the same as the MIC in the received data packet. The MIC verification predictor 532b may be configured to generate a MIC failure indication in instances where the local MIC is different from the MIC in the received data packet. In this regard, in a high SNR, a MIC failure indication may cause the transmit buffer 520 to retransmit the corresponding data packet to the slave device 300.

The CRC detector 534 may comprise suitable logic, circuitry, interfaces and/or code that may be enabled to detect errors in transmission and reception. In this regard, the CRC detector 534 may be configured to perform CRC detection based on a MIC indication message from the MIC verification predictor 532b. In a high SNR, the CRC detector 534 may be configured to escape CRC checking in instances where a MIC failure message received from the verification predictor 532b. Otherwise, the CRC detector 534 may be enabled to perform CRC checking on the received data packet. During CRC checking, the CRC detector 534 may be enabled to extract a CRC from the MIC detached data packet from the parser 532a.

The CRC detector 534 may be operable to calculate a local CRC for the associated PDU in the received data packet. The CRC detector 534 may be enabled to compare the local CRC with the CRC in the received data packet to determine whether the associated PDU in the received data packet is in error. If the local CRC is different from the CRC in the received data packet, the CRC detector 534 may determine that an error may have occurred in the received data packet and the PDU in the received data packet may not be valid. The CRC detector 534 may be enabled to send a CRC failure indication to the transmit buffer 520 to request retransmit the damaged PDU. If the local CRC is the same as the CRC in the received data packet, the CRC detector 534 may be enabled to acknowledge the PDU of the received data packet by sending a CRC success indication to the transmit buffer 520. The CRC success indication may trigger the transmit buffer 520 to start transmitting a new data packet.

Although the operating procedure illustrated in FIG. 5 is for transmission of a data packet from the master device 200 to the slave device 300, the invention is not so limited. In this regard, the operating procedure may also be applied to the transmission of a data packet from the slave device 300 to the master device 200 without departing from the spirit and scope of the various embodiments of the invention.

In an exemplary operation, the master device 200 may need to transmit a message using one or more PDUs to an intended slave device such as the slave device 300 in an encrypted link layer connection. A PDU for transmission may be error protected via the error protector 510. The error protector 510 may be operable to apply various error protection schemes such as MIC verification and/or CRC checking for the PDU. The MIC encoder 512 may be enabled to calculate a MIC and attach to the end of transmission content to form a PDU. The CRC encoder 514 may be enabled to calculate a CRC on the PDU and append the calculated CRC to the end of the PDU to form a data packet for transmission. The data packet may be stored in the transmit buffer 520 for transmission. The transmit buffer 520 may be enabled to transmit the transmission data packet to the slave device 300 in the encrypted link layer connection.

For the reception, the slave device 300 may enable error detections on the received data packet via the MIC detector 532 and/or the CRC detector 534, respectively. The parser 532a in the MIC detector 532 may be operable to analyze bitstreams of the received data packet and extract a MIC from the received data packet. The parser 532a may be enabled to communicate the remaining of the received data packet to the MIC verification predicator 532b and CRC detector 534, respectively. The parser 532a may be enabled to communicate the extracted MIC to the MIC verification predicator 532b. The MIC verification predicator 532b may be enabled to calculate a local MIC for the PDU in the received data packet. The MIC verification predicator 532b may be operable to compare the local MIC with the extracted MIC to determine potential packet content altercation in the received data packet. The MIC verification predicator 532b may be enabled to send a MIC failure indication to the transmit buffer 520 in instances where the local MIC is different from the extracted MIC. Otherwise, a MIC success indication may be provided to the transmit buffer 520. The MIC success indication or the MIC failure indication may also be sent to the CRC detector 534 to turn ON or turn OFF CRC checking.

In a high SNR condition, the CRC detector 534 may be configured to bypass CRC checking in instances where a MIC failure indication is received. Otherwise, the CRC detector 534 may be enabled to perform CRC checking on the received packet to provide CRC detection information to the transmit buffer 520. The transmit buffer 520 may be configured to manage packet transmission and/or retransmission based on MIC verification information and/or CRC detection information from the slave device 300. For example, in a high SNR, the transmit buffer 520 may be enabled to manage packet transmission and retransmission based on MIC verification information alone from the slave device 300. Otherwise, the transmit buffer 520 may be enabled to control packet transmission and retransmission based on both MIC verification information and CRC detection information from the slave device 300.

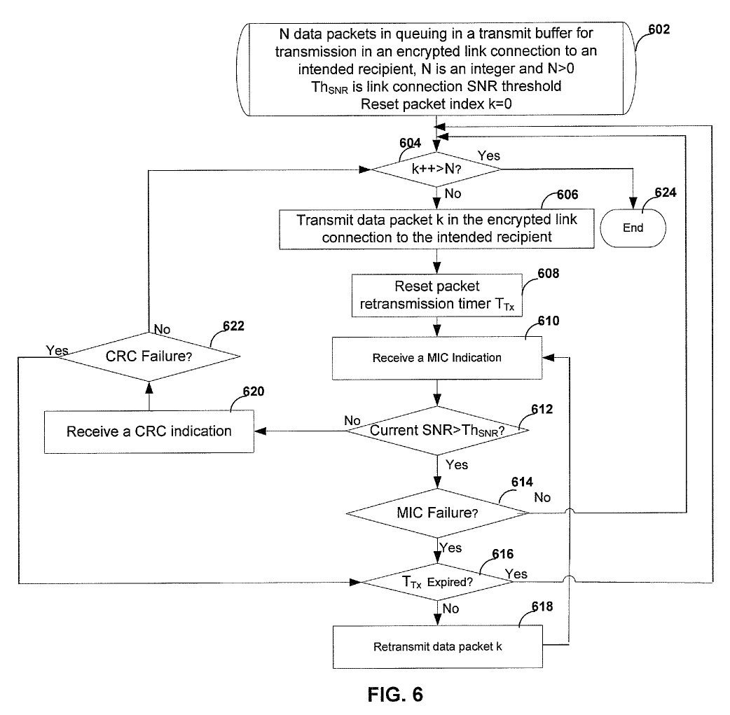

FIG. 6 is a flow chart illustrating exemplary steps in which a message integrity code is utilized for determining packet re-transmissions, in accordance with an embodiment of the invention. Referring to FIG. 6, the exemplary steps start with step 602, where N data packets may be queued in the transmit buffer 520 for transmission in an encrypted link connection, where N is an integer and N≧1. Th_{SNR} is a SNR threshold associated with the encrypted link connection and k is a packet index, which is reset to k=0. In step 604, the packet index k may be incremented by one. It may be determined whether the packet index k>N. In instances where it may be determined that k≦N, then in step 606, where data packet k may be transmitted in the encrypted link connection to an intended recipient. In step 608, a packet retransmission timer T_{TX} may be reset. The packet retransmission timer T_{TX} may be utilized to provide a reset to a sender in instances when a timer utilized for retransmission expires. In step 610, a MIC indication may be received from the intended recipient. In step 612, it may be determined that if the current SNR associated with the encrypted link connection is greater than Th_{SNR}. In instances where it may be determined that the current SNR associated with the encrypted link connection is greater than Th_{SNR}, then in step 614, it may be determined that a MIC failure is presented in the received MIC indication. In instances where it may be determined that a MIC failure is presented in the received MIC indication, then in step 616, it may be determined whether the packet retransmission timer T_{TX} may have expired. In instances where the T_{TX} may not be expired, then in step 618, the data packet k may be retransmitted in the encrypted link layer connection to the intended recipient. The number of times that the packet may be retransmitted may be configured at the recipient depending on service and/or device capability, for example. The exemplary steps may return to the step 610.

In step 604, in instances where it may be determined that k>N, then the exemplary process may stop in step 614.

In step 612, in instances where it may be determined that the current SNR associated with the encrypted link connection is less than or equal to Th_{SNR}, then in step 620, a CRC indication may be received from the intended recipient. In step 622, it may be determined whether a CRC failure occurred based on the received CRC indication. In instances where it may be determined that a CRC failure occurred, then the exemplary steps continue with step 616, otherwise the exemplary steps continue with step 604.

In step 614, in instances where it may be determined that a MIC success is present in the received MIC indication, then the exemplary steps may return to the step 604.

In step 616, it may be determined that the T_{TX} for the data packet k may have expired, the exemplary steps may return to the step 604.

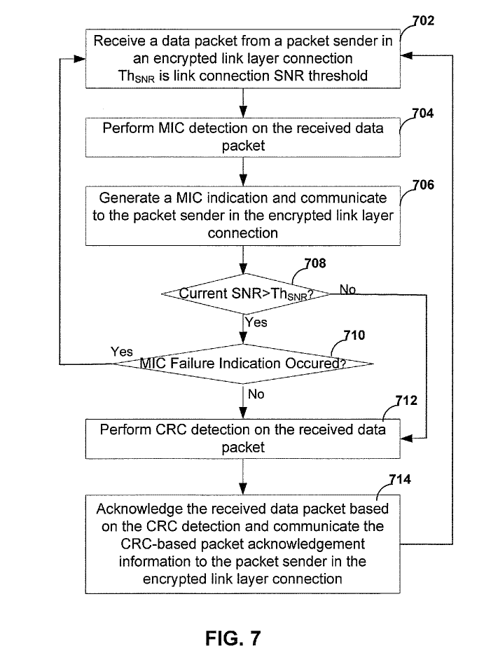

FIG. 7 is a flow chart illustrating exemplary steps to determine packet re-transmission based on an adaptive CRC detection, in accordance with an embodiment of the invention. Referring to FIG. 7, the exemplary steps start with step 702, where a BLE device such as the slave device 300 may be enabled to receive a data packet in an encrypted link connection from, for example, the master device 200. The received data packet comprises a transmitted PDU and a CRC. The transmitted PDU comprises a MIC. Th_{SNR} is a SNR threshold associated with the encrypted link layer connection.

In step 704, the slave device 300 may be enabled to perform MIC verification on the received data packet. The slave device 300 may be enabled to calculate a local MIC for the received transmitted PDU. The local MIC may be compared to the MIC in the received data packet. In step 706, the slave device 300 may be operable to generate a MIC indication based on the MIC verification. A MIC success indication may be generated in instances where the local MIC is the same as the MIC in the received data packet. A difference between the local MIC and the MIC in the received data packet may result in generation of a MIC failure indication. The generated MIC success indication or MIC failure indication may be communicated to the master device 200 via the encrypted link connection.

In step 708, it may be determined whether current SNR associated with the encrypted link layer connection may be greater than the SNR threshold Th_{SNR}. In instances where the current SNR is greater than Th_{SNR}, then in step 710, it may be determined that a MIC failure indication occurred. In instances where it may be determined that a MIC failure indication may be presented from the MIC verification, the slave device 300 may be configured to escape CRC detection on the received data packet and the exemplary steps return to the step 702 to receive a data packet retransmitted from the master device 200.

In step 708, in instances where it may be determined that current SNR is not greater than Th_{SNR}, then in step 712, the slave device 300 may be enabled to perform CRC detection on the received data packet. The slave device 300 may be enabled to calculate a local CRC on the received transmitted PDU in the received data packet. The local CRC may be compared to the CRC in the received data packet. In step 714, the slave device 300 may be enabled to generate a CRC indication based on the comparison between the local CRC and the CRC in the received data packet. If the local CRC is the same as the CRC in the received data packet, the received data packet may be acknowledged by generating a CRC success indication. A difference of the local CRC and the CRC in the received data packet may result in the received data packet being un-acknowledged, thereby causing a CRC failure indication. The exemplary steps return to the step 702 to receive a data packet from the master device 200.

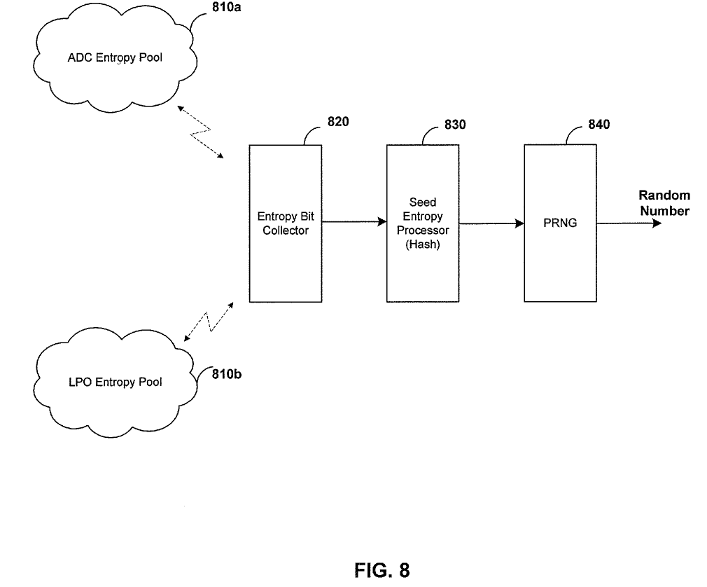

FIG. 8 is a diagram illustrating an exemplary pseudo random number generator that generates a random number using multiple entropy pools for generation of a secret Encryption Key, in accordance with an embodiment of the invention. Referring to FIG. 8, there is shown an ADC entropy pool 810a, a LPO entropy pool 810b, an entropy bit collector 820, a seed entropy processor 830, and a pseudo random number generator 840.

The ADC entropy pool 810a may comprise suitable logic, circuitry, interfaces and/or code that may be enabled to gather inherent randomness of various occasional and/or unlikely events on an analog digital conversion (ADC). The ADC entropy pool 810a may be enabled to collect inherent randomness from ADC quantization noise. The ADC entropy pool 810a may be utilized to produce numbers in a non-discernable sequence. For example, for a thermal noise input, the LSB of an ADC may be characterized by a random bit toggling between 1 and 0. For a Delta-Sigma ADC, an input signal may be oversampled relative to the input signal bandwidth. The resulting quantization noise may be shaped to high frequency regions. The high frequency regions, for example, a region in the half of a corresponding sampling frequency, may be much higher than the low frequency band for the input signal. In this regard, a high-pass filter may be utilized to extract the thermal noise from the higher frequency regions during corresponding delta-sigma ADC process. The extracted thermal noise may be used to produce random bits for the ADC entropy pool 810a. The random bits may be generated at the rate of the oversampling frequency and a plurality of random bits may be generated in a short amount of time.

The LPO entropy pool 810b may comprise suitable logic, circuitry, interfaces and/or code that may be enabled to gather inherent randomness of various occasional and/or unlikely events on a low power oscillator (LPO). The LPO entropy pool 810b may be enabled to collect inherent randomness from LPO events. The LPO entropy pool 810b may be utilized as a resource to produce numbers in a non-discernable sequence. For example, since the LPO is poor in frequency stability, the LPO events such as spacing between ticks of an associated LPO counter may not be very accurate relative to the accuracy of a high speed clock. In this regard, the number of cycles of the high speed clock between successive ticks of the LPO counter may be counted. The LSBs of the resulting accumulated counting values may be used to produce random bits for the LPO entropy pool 810b.

The ADC entropy pool 810a and the LPO entropy pool 810b may be utilized by the entropy bit collector 820 to collect entropy bits. The collected entropy bits may be utilized for various purposes such as, for example, to serve as the basis for creating a secret Encryption Key.

The entropy bit collector 820 may comprise suitable logic, circuitry, interfaces and/or code that may be enabled to collect entropy bits from multiple entropy pools such as the ADC entropy pool 810a and the LPO entropy pool 810b. The entropy bit collector 820 may be enabled to transform entropy from the ADC entropy pool 810a and the LPO entropy pool 810b into one or more sets of entropy bits. The entropy bit collector 820 may be configured to continuously collect a set of entropy bits, which may be as large as 2⁶⁴−1, from the ADC entropy pool 810a and the LPO entropy pool 810b. For example, after the set of 4019 entropy bits have been collected from the ADC entropy pool 810a and the LPO entropy pool 810b, the oldest entropy bits in the entropy bit collector 820 may be discarded in order to free memory for new entropy bits.

The seed entropy processor 830 may comprise suitable logic, circuitry, interfaces and/or code that may be enabled to process entropy bits collected from the ADC entropy pool 810a and the LPO entropy pool 810b. The seed entropy processor 830 may be enabled to compress collected entropy bits to, for example, a set of 128 seed entropy bits needed for generating a secret Encryption Key. The seed entropy processor 830 may be enabled to incorporate a hash algorithm on the collected entropy bits to produce the set of 128 seed entropy bits from the collected set of, for example, 4019 entropy bits. The set of 128 seed entropy bits may be communicated with the pseudo random number generator 840.

The pseudo random number generator 840 may comprise suitable logic, circuitry, interfaces and/or code that may be enabled to generate pseudorandom numbers for different purposes such as, for example, a secret Encryption Key. The pseudo random number generator 840 may be configured to generate a random number via a counter increment. The pseudo random number generator 840 may be fed with a set of seed entropy bits provided by the seed entropy processor 830. A pseudo-random number algorithm such as AES-128 PRNG may be utilized to produce a 128-bit random number. The pseudo random number generator 840 may be reseeded after, for example, 32 random numbers have been generated.

In operation, inherent randomness of various occasional and/or unlikely events such as LPO events and ADC quantization noise components may be gathered to form the ADC entropy pool 810a and the LPO entropy pool 810b, respectively. The entropy bit collector 820 may be enabled to transform entropy gathered in multiple entropy pools such as the ADC entropy pool 810a and the LPO entropy pool 810b into one or more sets of entropy bits. The seed entropy processor 830 may be enabled to process entropy bits collected from the ADC entropy pool 810a and the LPO entropy pool 810b. The seed entropy processor 830 may be operable to produce seed entropy to feed the pseudo random number generator 840. The pseudo random number generator 840 may be enabled to generate random numbers such as a 128-bit random number, which may be utilized to calculate various authentication keys such as an AES secret key and/or a MIC secret key.

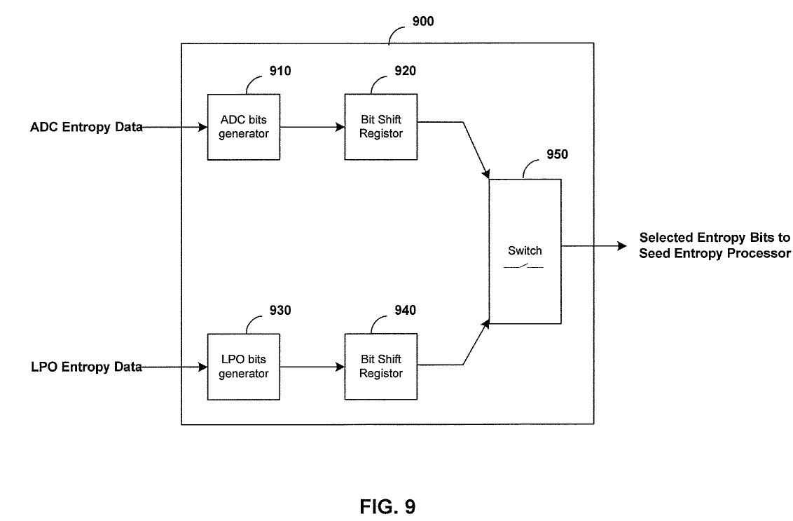

FIG. 9 is a diagram illustrating an exemplary entropy bit collector that is operable to collect entropy bits in multiple entropy pools for generating a random number for generation of a secret Encryption Key, in accordance with an embodiment of the invention. Referring to FIG. 9, there is shown an entropy bit collector 900. The entropy bit collector 900 comprises an ADC bits generator 910, an ADC bit shift register 920, a LPO bits generator 930, and a LPO bit shift register 940 and a switch 950.

The ADC bits generator 910 may comprise suitable logic, circuitry, interfaces and/or code that may be enabled to transform entropy gathered from noise components of an ADC such as a delta-sigma ADC to ADC entropy bits for seed entropy bits. A delta-sigma ADC may be operable to convert an analog-input signal such as AC or DC voltage signal into a high-speed, pulse-wave representation. The delta-sigma ADC may be configured to perform various operations such as, for example, over-sampling and digital filtering. In this regard, the high-frequency noise components in the output of the delta-sigma ADC may be filtered via a digital high pass filter to form ADC entropy bits.

The ADC bit shift register 920 may comprise suitable logic, circuitry, interfaces and/or code that may be enabled to shift a serial bit stream into the register with multiple clock pulses. The ADC bit shift register 920 may be continuously filled with ADC entropy bits from the ADC bits generator 910. The oldest bits in the ADC bit shift register 920 may be discarded in order to make room for new ADC entropy bits. The ADC bit shift register 920 may be controlled by the seed entropy processor 830 to start or stop collecting ADC entropy bits. Contents of the ADC bit shift register 920 may be communicated to the seed entropy processor 830 while ADC entropy bits collection is still in progress. The operation of the ADC bit shift register 920 may be disabled between reseeds of the PRNG 840.

The LPO bits generator 930 may comprise suitable logic, circuitry, interfaces and/or code that may be enabled to collect LSBs of clock ticks of an internal LPO within each counter increment of the PRNG 840. The internal LPO may be featured with poor frequency accuracy and may run completely asynchronously to, for example, a 24 MHz clock. The collected LSBs of clock ticks may be concatenated to form long words in the entropy pool 810b.

The LPO bit shift register 940 may comprise suitable logic, circuitry, interfaces and/or code that may be enabled to shift a serial bit stream into the register with multiple clock pulses. The LPO bit shift register 940 may be continuously filled with LPO entropy bits from the LPO bits generator 940. The oldest bits in the LPO bit shift register 940 may be discarded in order to make room for new LPO bits. The LPO bit shift register 940 may be controlled by the seed entropy processor 830 to start or stop collecting LPO entropy bits. Contents of the LPO bit shift register 940 may be communicated to the seed entropy processor 830 while LPO entropy bits collection is still in progress. The operation of the LPO bit shift register 940 may be disabled between reseeds of the PRNG 840.

The switch 950 may comprise suitable logic, circuitry, interfaces and/or code that may be enabled to sample ADC entropy bits and LPO entropy bits one or more times in the ADC bit shift register 920 and the LPO bit shift register 940, respectively. The switch 950 may be configured to concatenate multiple, for example, 128-bit words to form input to the seed entropy processor 830.

In operation, the entropy bit collector 900 may be enabled to collect entropy bits from multiple entropy pools such as the ADC entropy pool 810a and the LPO entropy pool 810b for seed entropy to the PNRG 840. The ADC bits generator 910 may be enabled transform entropy gathered from noise components of a delta-sigma ADC to ADC entropy bits. A serial ADC entropy bit stream from the ADC bits generator 910 may be shifted by the ADC bit shift register 920 to multiple output bitstreams. The LPO bits generator 930 may be enabled transform entropy gathered from LSBs of clock ticks of an internal LPO within each counter increment of the PRNG 840 to LPO entropy bits. A serial LPO bit stream from the LPO bits generator 930 may be shifted by the LPO bit shift register 940 to multiple output bitstreams. The switch 950 may be enabled to sample ADC entropy bits and LOP entropy bits from the ADC bit shift register 920 and the LPO bit shift register 940, respectively. The switch 950 may be enabled to concatenate several 128-bit words, for example, to form input to the seed entropy processor 830.

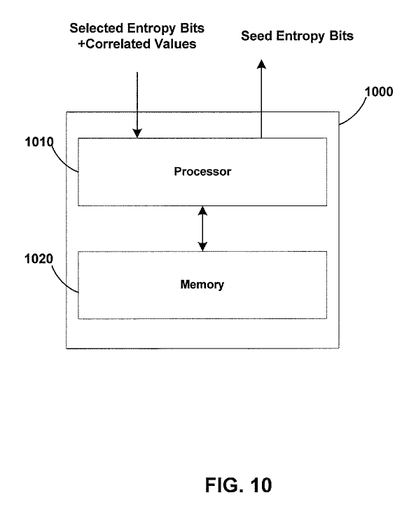

FIG. 10 is a diagram illustrating an exemplary seed entropy processor that is operable to select seed entropy from entropy bits collected in multiple entropy pools for generation of a secret Encryption Key, in accordance with an embodiment of the invention. Referring to FIG. 10, there is shown a seed entropy processor 1000. The seed entropy processor 1000 comprises a whitening processor 1010 and a memory 1020.

The whitening processor 1010 may comprise suitable logic, circuitry, interfaces and/or code that may be enabled to compress the accumulated input from the switch 950 to seed entropy bits needed for a secret key and counter utilized in the PRNG 840. The accumulated input length may be as large as 2⁶⁴−1 and corresponding output length may be 256 bits, for example. The whitening processor 1010 may be enabled to utilize various algorithms such as, for example, SHA-256 to compute a message digest ranging in length from 160 to 512 bits, depending on the algorithm. The accumulated input ADC entropy bit and LPO entropy bits may be partitioned into input blocks of, for example, 512 bits, to SHA-256. A secure hash algorithm may be used to pick, for example, 128 bits from the message digest in the output of the SHA-256 while preserving entropy found in the message digest. The secure hash algorithm may ensure to produce numbers indistinguishable from truly random values.

The memory 1020 may comprise suitable logic, circuitry, interfaces and/or code that may enable storage of data and/or other information utilized by the processor 1010. For example, the memory 1020 may be utilized to store data accumulated from the entropy bits collector 900. The memory 1020 may be enabled to store executable instructions received from the PRNG 840. The memory 1020 may comprise RAM, ROM, low latency nonvolatile memory such as flash memory and/or other suitable electronic data storage capable of storing data and instructions.

In operation, the seed entropy processor 1000 may be enabled to process entropy bits collected from the ADC entropy pool 810a and the LPO entropy pool 810b. The whitening processor 1010 may be enabled to whiten and compress the accumulated ADC bits and/or LPO bits from the switch 950 to seed entropy bits needed. The seed entropy bits may be utilized for a secret key and counter utilized in the PRNG 840. The number of the accumulated ADC entropy bits and/or LPO entropy bits may be as large as 2⁶⁴−1 and an output bit sequence length may be 256 bits, for example. The whitening processor 1010 may be enabled to utilize various algorithms such as, for example, SHA-256 on the accumulated ADC entropy bits and/or LPO entropy bits to output a message digest ranging in length from 160 to 512 bits depending on the algorithm. A secure hash algorithm may be utilized to pick 128 bits out of corresponding bits of the message digest while preserving entropy. The use of the secure hash algorithm may ensure numbers produced via the secure hash algorithm indistinguishable from truly random values.

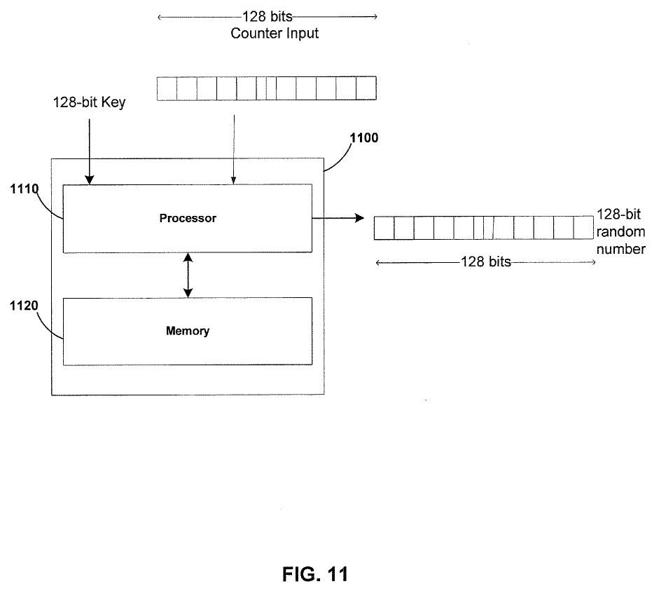

FIG. 11 is a diagram illustrating an exemplary pseudo random generator that is operable to generate a random number using multiple entropy pools for generation of a secret Encryption Key, in accordance with an embodiment of the invention. Referring to FIG. 11, there is shown a pseudo random generator 1100 comprising a processor 1110 and a memory 1120.

The processor 1110 may comprise suitable logic, circuitry, interfaces and/or code that may be enabled to perform encryption operation on a counter input using a secret key provided by the seed entropy processor 830. Both the secret key and the counter input may be provided by the seed entropy processor 830. The processor 1110 may be enabled to apply various algorithms such as an AES-128 algorithm to produce a 128-bit random number using a 128-bit secret key for generating a 128-bit secret Encryption Key, for example. The processor 1110 may be reseeded after generating, for example, 32 new random numbers. The processor 1110 may communicate with the seed entropy processor 830 for reseeding. Accordingly, the ADC bit shift register 920 and the LPO bit shift register 940 may be enabled to accumulate a new set of entropy bits from the ADC entropy pool 810a and the LPO entropy pool 810b, respectively, for the reseeding. The processor 1110 may not be allowed to reuse the 128-bit key may for other purposes such as such as key in AES-CCM.

The memory 1120 may comprise suitable logic, circuitry, interfaces and/or code that may enable storage of data and/or other information utilized by the processor 1110. For example, the memory 1120 may be utilized to store one or more secret keys and counter input provided by the seed entropy processor 830. The memory 1020 may be enabled to store executable instructions to the seed entropy processor 830 from the PRNG 840. The memory 1120 may comprise RAM, ROM, low latency nonvolatile memory such as flash memory and/or other suitable electronic data storage capable of storing data and instructions.

In an exemplary operation, the processor 1110 may be enabled to perform encryption operation such as ciphering on, for example, a 128-bit counter input using a 128-bit key. The 128-bit counter input and the 128-bit key are provided by the seed entropy processor 830. The processor 1110 may be configured to apply an AES-128 algorithm to output a 128-bit random number. The processor 1110 may be enabled to generate a 128-bit random number for output via a counter increment in the counter input. The processor 1110 may be configured for reseed every 32 new random number generation.

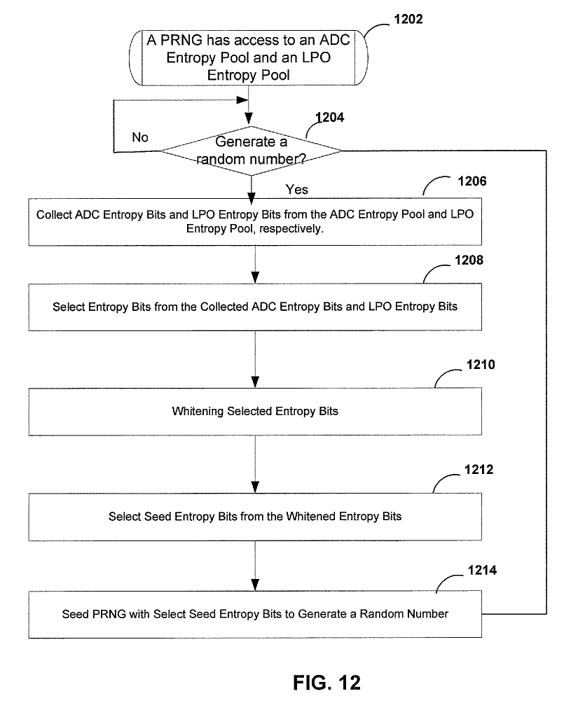

FIG. 12 is a flow chart illustrating exemplary steps to generate a random number using a multiple entropy pools for generation of a secret Encryption Key, in accordance with an embodiment of the invention. The exemplary steps start with step 1202, where the PRNG 840 may have access to the ADC entropy pool 810a and the LPO entropy pool 810b. In step 1204, it may be determined whether a random number is to be generated. In instances where a random number is to be generated, then in step 1206, the entropy bit collector 820 may be enabled to collect ADC entropy bits and LPO entropy bits from the ADC entropy 810a and the LPO entropy pool 810b, respectively. In step 1208, the entropy bit collector 820 may be enabled to select entropy bits from the collected ADC entropy bits and LPO entropy bits. In step 1210, the seed entropy processor 830 may be enabled to process the selected entropy bits from the entropy bit collector 820. The selected entropy bits may be whitened using, for example, SHA-256 to result in 160-512 bits depending implementation. In step 1212, the entropy bit collector 820 may be enabled to apply a harsh algorithm to select seed entropy bits from the whitened entropy bits. In step 1214, the seed entropy may be utilized to seed the PRNG 840 for generating a random number. The exemplary steps may return to the step 1204.

In step 1204, in instances when no random number is to be generated, then the exemplary steps may stay in step 1204.

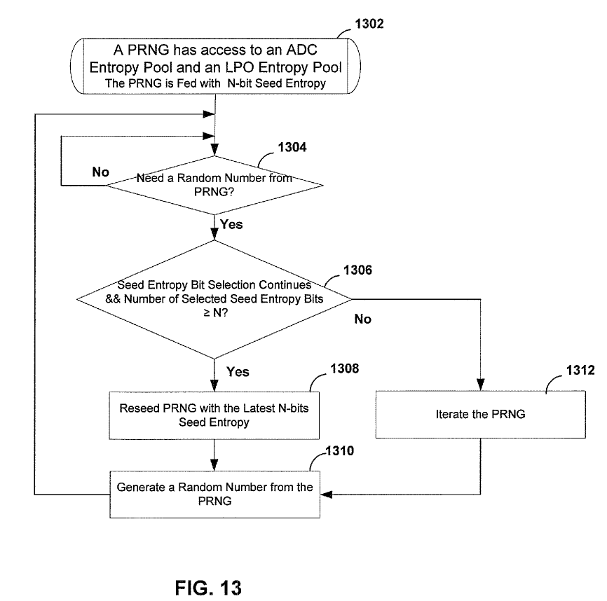

FIG. 13 is a flow chart illustrating exemplary steps to expedite random number generation by iterating a pseudo random generator for generation of a secret Encryption Key, in accordance with an embodiment of the invention. The exemplary steps start with step 1302, where PRNG 840 may have access to the ADC entropy pool 810a and the LPO entropy pool 810b, respectively. The PRNG 840 may be fed with N-bit seed entropy from the seed entropy processor 830. In step 1304, it may be determined whether a random number is to be generated by the PRNG 840. In instances where it may be determined that a random number is to be generated by the PRNG 840, then in step 1306, it may be determined whether the entropy bit collector 820 may continue selecting seed entropy bits from the ADC entropy pool 810a and the LPO entropy pool 810b and the number of currently selected seed entropy bits≧N. In instances where it may be determined that the entropy bit collector 820 should continue selecting seed entropy bits from the ADC entropy pool 810a and the LPO entropy pool 810b and the number of currently selected seed entropy bits≧N, then in step 1308, where the PRNG 840 may be reseeded with the latest N-bits seed entropy. In step 1310, the PRNG 840 may be enabled to generate a random number. The exemplary steps may return to step 1304.

In step 1306, in instances where it may be determined that the entropy bit collector 820 should not continue selecting seed entropy bits from the ADC entropy pool 810a and the LPO entropy pool 810b and/or the number of currently selected seed entropy bits<N, then in step 1312, the PRNG 840 may be configured to be iterated. The exemplary process may continue in step 1310.

Aspects of a method and system for power saving in packet re-transmission in an encrypted Bluetooth low power layer connection are provided. In accordance with various exemplary embodiments of the invention, referring to FIG. 5, a Bluetooth low power receiver such as the slave device 120d may be enabled to receive a data packet in an encrypted link layer connection from a Bluetooth low power (BLE) transmitter such as the master device 110. The data packet may comprise a transmission protocol data unit (PDU) and associated cyclic redundancy code (CRC), and the transmission PDU comprises a message integrity code (MIC) as presented in FIG. 4.

The slave device 120d may be operable to determine SNR associated with the encrypted link layer connection. The slave device 120d may be enabled to parse the received data packet for the associated MIC in the transmitted PDU. The associated MIC may be detected or verified for data integrity via the MIC verification predicator 522b. In instances where a high SNR condition may be associated with the encrypted link layer connection, the slave device 120d may be configured to determine whether the received data packet should be retransmitted based on the results from the MIC verification in the MIC verification predicator 522b. In the MIC verification predicator 522b, a local MIC may be calculated for the transmitted PDU in the received data packet using a secret Encryption Key, which is shared with the master device 110.

The MIC verification predicator 522b may be enabled to compare the calculated local MIC with the MIC in the received data packet. The MIC verification predicator 522b may be operable to generate a MIC indication based on the comparison. A MIC success indication may be generated in instances where the local MIC is the same as the MIC in the received data packet. A MIC failure indication may be generated in instances where the local MIC is different from the MIC in the received data packet. The generated MIC indication may be utilized for data authentication at the slave device 120d. Moreover, the CRC detector 524 may be configured to determine whether to turn ON or OFF CRC checking to achieve power saving based on the received data packet based on the generated MIC indication as well as the determined signal-to-noise ratio (SNR) associated with the encrypted link layer connection with the master device 110.

In instances where the encrypted link connection may be in a high SNR condition, a MIC failure indication from the MIC verification predicator 522b may be utilized to determine to retransmit the received data packet without performing CRC checking at the CRC detector 524. The secret Encryption Key shared by the master device 110 and the slave device 120d may be derived from a random number sequence. The random number sequence may be generated by the PRNG 840. The PRNG 840 may be fed with seed entropy provided by the seed entropy processor 830. The seed entropy processor 830 may be enabled to collect entropy bits from multiple entropy pools such as, for example, the ADC entropy pool 810a and the LPO entropy pool 810b.

The ADC entropy pool 810a may be formed by gathering inherent randomness of various occasional and/or unlikely events on an analog digital conversion (ADC) such as a delta-sigma ADC. The ADC entropy pool 810a may comprise entropy collected from high-frequency noise components in the output of a delta-sigma ADC. The LPO entropy pool 810b may be formed by gathering inherent randomness from LPO events such as LSBs of clock ticks of an internal LPO within each counter increment of the PRNG 840. The PRNG 840 may be fed with seed entropy of 32-bit, 64-bit, or 128-bit to generate random numbers of 32-bit, 64-bit, or 128-bit, respectively. The generated random numbers of 32-bit, 64-bit, or 128-bit may be utilized for various purposes such as, for example, to serve as the basis for creating a secret Encryption Key of 32-bit, 64-bit, or 128-bit, respectively.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for saving power for packet re-transmission in an encrypted Bluetooth low power layer connection.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of processing signals, the method comprising:
performing by one or more processors and/or circuits in a Bluetooth low power (BLE) receiver:
receiving a data packet in an encrypted link layer connection from a Bluetooth low power (BLE) transmitter, wherein said data packet comprises a transmitted protocol data unit (PDU) and associated cyclic redundancy code (CRC), and said PDU comprises a message integrity code (MIC);
determining a signal to noise ration (SNR ) of said encrypted link layer connection; and
determining whether said data packet is to be retransmitted based on said MIC and said determined signal to noise ratio, wherein a CRC of said received data packet is not checked when said signal-to-noise ratio (SNR) is greater than a specified threshold.

2. The method according to claim 1, comprising calculating a local MIC for said transmitted PDU using a secret Encryption Key that is shared with said BLE transmitter.

3. The method according to claim 2, comprising comparing said calculated local MIC with said MIC in said received data packet.

4. The method according to claim 3, comprising generating a MIC indication based on said comparison.

5. The method according to claim 4, comprising turning ON or OFF CRC checking to achieve power saving based on said generated MIC indication and/or said determined signal-to-noise ratio (SNR).

6. The method according to claim 5, comprising determining whether to retransmit said data packet without said CRC checking when said generated MIC indication indicates that said calculated local MIC is different from said MIC in said received data packet.

7. The method according to claim 2, wherein said secret Encryption Key is derived from a generated random number sequence.

8. The method according to claim 7, comprising generating said random number sequence by a random number generator fed with seed entropy from multiple entropy pools comprising an analog-to-digital convertor (ADC) entropy pool and a low power oscillator (LPO) entropy pool.

9. The method according to claim 8, wherein said ADC entropy pool and said LPO entropy pool are formed from occasional and/or unlikely events on an analog-to-digital convertor (ADC) and on a low power oscillator (LPO).

10. The method according to claim 8, wherein said random number sequence comprises a 32-bit, 64-bit, or 128-bit random number sequence for said secret Encryption Key.

11. A system for processing signals, the system comprising:
one or more processors and/or circuits for use a Bluetooth low power (BLE) receiver, wherein said one or more processors and/or circuits are operable to:
receive a data packet in an encrypted link layer connection from a Bluetooth low power (BLE) transmitter, wherein said data packet comprises a transmitted protocol data unit (PDU) and associated cyclic redundancy code (CRC), and said PDU comprises a message integrity code (MIC);
determine a signal to noise ration (SNR ) of said encrypted link layer connection; and
determine whether said data packet is to be retransmitted based on said MIC and said determined signal to noise ratio, wherein a CRC of said received data packet is not checked when said signal-to-noise ratio (SNR) is greater than a specified threshold.

12. The system according to claim 11, wherein said one or more processors and/or circuits are operable to calculate a local MIC for said transmitted PDU using a secret Encryption Key that is shared with said BLE transmitter.

13. The system according to claim 12, wherein said one or more processors and/or circuits are operable to compare said calculated local MIC with said MIC in said received data packet.

14. The system according to claim 13, wherein said one or more processors and/or circuits are operable to generate a MIC indication based on said comparison.

15. The system according to claim 14, wherein said one or more processors and/or circuits are operable to turn ON or OFF CRC checking to achieve power saving based on said generated MIC indication and/or said determined signal-to-noise ratio (SNR) associated with said encrypted link layer connection.

16. The system according to claim 15, wherein said one or more processors and/or circuits are operable to determine whether to retransmit said data packet without said CRC checking when said generated MIC indication indicates that said calculated local MIC is different from said MIC in said received data packet.

17. The system according to claim 12, wherein said secret Encryption Key is derived from a random number sequence.

18. The system according to claim 17, wherein said one or more processors and/or circuits are operable to generate said random number sequence by a random number generator fed with seed entropy from multiple entropy pools comprising an analog-to-digital convertor (ADC) entropy pool and a low power oscillator (LPO) entropy pool.

19. The system according to claim 18, wherein said ADC entropy pool and said LPO entropy pool are formed from occasional and/or unlikely events on an analog-to-digital convertor (ADC) and on a low power oscillator (LPO).

20. The system according to claim 18, wherein said random number sequence comprises a 32-bit, 64-bit, or 128-bit random number sequence for said secret Encryption Key.
